(19) United States
(12) Patent Application Publication
(10) Pub. No.: US 2025/0021294 A1
(43) Pub. Date: Jan. 16, 2025

(54) AUTOMATED AUDIO FURNISHING AMIDST READING OF A DIGITAL MEDIA

(71) Applicant: PES University, Bengaluru (IN)

(72) Inventors: SNEHA RAGHUNATHAN KOUSALYA, Bangalore (IN); RAMYAA VENKATESH, Bangalore (IN); PRARTHANA TEJASvI, Bangalore (IN)

(21) Appl. No.: 18/509,347

(22) Filed: Nov. 15, 2023

(30) Foreign Application Priority Data
Jul. 12, 2023 (IN) 202341046927

(51) Int. Cl. G06F 3/16; G06F 3/01

(52) U.S. Cl. CPC G06F 3/165; G06F 3/012; G06F 3/013

(57) ABSTRACT

A method for automated audio furnishing amidst reading of a digital media is disclosed. The method includes receiving data associated with the digital media that is displayed on an electronic device, display settings of the electronic device, and facial movement data of a user reading the digital media on the electronic device in real-time. The method includes determining portion of the digital media being read in real-time based on the received data associated with the digital media, display settings, and/or real-time facial movement. Further, the method includes generating an audio based on the received data associated with the digital media and the determined portion of the digital media. Thereafter, the method includes rendering the generated audio to the user in real-time, such that the user hears the generated audio while reading the determined portion of the digital media.

### BACKGROUND

### Technical Field

The present disclosure relates to the field of reading digital media, and in particular, relates to a system and method for automated audio furnishing amidst reading of the digital media.

### Description of the Related Art

Due to heavy weight, bulkiness, and non-portability, reading materials have paved the way into digital environment. As a result, the reading materials are now readily available to users via digital media such as digital documents, digital books, websites, images, and videos. As is well known, reading allows the readers to actively engage their imagination and create vivid mental images of the story, characters, and settings. It stimulates the reader's mind and encourages active participation in the storytelling process. Also, the reading materials have the ability to provide in-depth details and descriptions that can delve into the character's thoughts and emotions, resulting in a rich and immersive introspective manner. Additionally, the reading materials offer the readers the freedom to set their own pace while reading since the readers can pause, reflect, and revisit sections at their leisure. Such flexibility allows for a personalized and contemplative reading experience. Thus, reading remains a primary medium of story-telling for a large section of our society who prefer reading over watching videos/movies for improved focus, memory, empathy, and communication skills while reducing stress and improving mental health.

However, reading is usually plain and not as immersive as watching videos/movies. One of the reasons for such lack of immersive in contrast to watching videos/movies is the absence of relevant ambient audios that gets played during various scenes and dialogues like in videos/movies. For example, a thriller section of a book is plain just like a comedy section and/or a horror section but the videos/movies have a suspense audio during the thriller section, a funny audio during the comedy section, and a scary audio during the horror section which makes the user experience more immersive and engaging.

Therefore, there is a need for an improved technology for making reading of the digital media more immersive and engaging for the readers and improving their user experience.

### BRIEF SUMMARY OF THE DISCLOSURE

One or more embodiments are directed to a system and method for automated audio furnishing amidst reading of a digital media. The system provides an immersive reading experience to users (also referred to as a readers) through AI-aided ambient audio (also termed as music) generation based on the user's reading speed. The generated ambient music advances along the varying progression of themes and moods in reading content facilitating the user with an immersive and multi-sensorial experience. In order to generate the music, the system scans the reading content of the digital media to pick out a general genre and vibe of the digital media. Upon picking out the general genre, the system starts looking into various sections of the digital media to pick out their context. Additionally, the system also determines a paragraph-to-paragraph transition and flow of the theme in the digital media. Further, when the reader is reading the digital media, the system tracks the user's eye movement and/or the head movement to determine the focus of the reader with respect to the displayed digital media. Accordingly, the system keeps track of the portion of the digital media that the reader is reading at a particular point of time as well as the reading speed to render the generated music accordingly while smoothly transitioning the generated music with the flow of the theme of the digital media to provide ambient and intune experience to the reader.

An embodiment of the present disclosure discloses the system for automated audio furnishing amidst reading of the digital media. The digital media corresponds to a media having textual content and includes a document, a website, an image, a video, or a combination thereof. The system includes a receiver module to receive data associated with the digital media that is displayed on an electronic device, display settings of the electronic device, and facial movement data of a user reading the digital media on the electronic device in real-time. The data associated with the digital media includes title, genre, content of the digital media, or a combination thereof. The display settings include the position of the digital media on a display of the electronic device and/or a zoom level associated with the displayed digital media. The facial movement data corresponds to data associated with eye-movement and head-movement of the user while reading the digital media on the electronic device. The electronic device corresponds to a digital display device having a camera and includes, without any limitation, a mobile phone, a Personal Digital Assistant (PDA), a tablet, a desktop, a laptop, a television, or a smartboard.

In an embodiment, the system includes a gaze tracking module to determine a portion of the digital media being read in real-time based on the received data associated with the digital media, display settings, real-time facial movement, or a combination thereof. In order to determine the portion of the digital media being read, the gaze tracking module extracts one or more features from the received facial movement data. The one or more features include ocular co-ordinates and/or head co-ordinates of the user. Upon extracting the one or more features, the gaze tracking module identifies a user focus position on a display of the electronic device by analyzing the one or more extracted features. Further, the gaze tracking module identifies the content of the digital media being displayed in proximity to the identified user focus position to determine the portion of the digital media being read. Additionally, the gaze tracking module also determines a user's reading speed by tracking the identified user's focus position. It may be noted that the user's reading speed may also be pre-determined and pre-stored based on a sample reading material.

In an embodiment, the system also includes an Artificial Intelligence (AI) audio generation module to generate audio based on the received data associated with the digital media and/or the determined portion of the digital media. In order to generate the audio, the AI audio generation module identifies the genre of the digital media based on the received data and determines the context of the portion of the digital media being read in real-time by employing a Recurrent Neural Network (RNN). Further, the Ai audio generation module generates the audio based at least on the identified genre of the digital media and/or the determined context of the portion being read by employing a Machine Learning (ML) model.

In an embodiment, the system includes a rendering module to render the generated audio to the user in the real-time, such that the user hears the generated audio while reading the determined portion of the digital media. The rendering module renders the generated audio based on the user's reading speed. In some embodiments, the AI audio generation module is further configured to identify adjacent portions to the portion of the digital media being read for generating one or more audios based on the adjacent portions to facilitate the rendering module for smooth transitioning from one audio to another while rendering to the user.

An embodiment of the present disclosure discloses a method for automated audio furnishing amidst reading of a digital media. The method includes receiving data associated with the digital media that is displayed on an electronic device, display settings of the electronic device, and facial movement data of a user reading the digital media on the electronic device in real-time. The data associated with the digital media includes title, genre, content of the digital media, or a combination thereof. The display settings include the position of the digital media on a display of the electronic device and/or a zoom level associated with the displayed digital media. The facial movement data corresponds to data associated with eye-movement and head-movement of the user while reading the digital media on the electronic device.

In an embodiment, the method includes the steps of determining a portion of the digital media being read in real-time based on the received data associated with the digital media, display settings, real-time facial movement, or a combination thereof. In order to determine the portion of the digital media being read, the method includes the steps of extracting one or more features from the received facial movement data, identifying a user focus position on a display of the electronic device by analyzing the one or more extracted features, and identifying the content of the digital media being displayed in proximity of the identified user focus position to determine the portion of the digital media being read. Additionally, the method includes determining a user's reading speed by tracking the identified user's focus position. It may be noted that the user's reading speed may also be pre-determined and pre-stored based on a sample reading material.

In an embodiment, the method includes the steps of generating an audio based on the received data associated with the digital media and/or the determined portion of the digital media. In order to generate the audio, the method includes the steps of identifying the genre of the digital media based on the received data, determining the context of the portion of the digital media being read in real-time by employing a Recurrent Neural Network (RNN); and generating the audio based on the identified genre of the digital media and/or the determined context of the portion being read by employing a Machine Learning (ML) model.

In an embodiment, the method includes the steps of rendering the generated audio to the user in the real-time, such that the user hears the generated audio while reading the determined portion of the digital media. Additionally, the method includes the steps of identifying adjacent portions to the portion of the digital media being read and generating one or more audios based on the adjacent portions to facilitate the rendering module for smooth transitioning from one audio to another while rendering to the user

The Features and advantages of the subject matter here will become more apparent in light of the following detailed description of selected embodiments, as illustrated in the accompanying FIGUREs. As will be realized, the subject matter disclosed is capable of modifications in various respects, all without departing from the scope of the subject matter. Accordingly, the drawings and the description are to be regarded as illustrative in nature.

### BRIEF DESCRIPTION OF THE DRAWINGS

In the figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 illustrates a block diagram of an environment of a system for automated audio furnishing amidst reading of a digital media, in accordance with various embodiments of the present disclosure.

FIG. 2 illustrates a block diagram of the system for automated audio furnishing amidst reading of the digital media, in accordance with various embodiments of the present disclosure.

FIG. 3 illustrates an exemplary implementation of the system for automated audio furnishing amidst reading of the digital media, in accordance with various embodiments of the present disclosure.

FIG. 4A illustrates a broad level block diagram for determining various contexts of the digital media, in accordance with various embodiments of the present disclosure.

FIG. 4B illustrates a narrow level block diagram for determining context of a chapter of the digital media, in accordance with various embodiments of the present disclosure.

FIG. 5 illustrates a block diagram for digital media progress tracking of a user by a gaze tracking module, in accordance with various embodiments of the present disclosure.

FIG. 6 illustrates a block diagram for audio generation by an AI-audio generation module, in accordance with various embodiments of the present disclosure.

FIG. 7 illustrates a flowchart of a method for automated audio furnishing amidst reading of a digital media, in accordance with an embodiment of the present disclosure.

FIG. 8 illustrates an exemplary computer system in which or with which embodiment of the present disclosure may be utilized.

Other features of embodiments of the present disclosure will be apparent from accompanying drawings and detailed description that follows.

### DETAILED DESCRIPTION OF THE DISCLOSURE

Embodiments of the present disclosure include various steps, which will be described below. The steps may be performed by hardware components or may be embodied in machine-executable instructions, which may be used to cause a general-purpose or special-purpose processor programmed with the instructions to perform the steps. Alternatively, steps may be performed by a combination of hardware, software, firmware, and/or by human operators.

Embodiments of the present disclosure may be provided as a computer program product, which may include a machine-readable storage medium tangibly embodying thereon instructions, which may be used to program the computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other types of media/machine-readable medium suitable for storing electronic instructions (e.g., computer programming code, such as software or firmware).

Various methods described herein may be practiced by combining one or more machine-readable storage media containing the code according to the present disclosure with appropriate standard computer hardware to execute the code contained therein. An apparatus for practicing various embodiments of the present disclosure may involve one or more computers (or one or more processors within the single computer) and storage systems containing or having network access to a computer program(s) coded in accordance with various methods described herein, and the method steps of the disclosure could be accomplished by modules, routines, subroutines, or subparts of a computer program product.

### Terminology

Brief definitions of terms used throughout this application are given below.

The terms “connected” or “coupled”, and related terms are used in an operational sense and are not necessarily limited to a direct connection or coupling. Thus, for example, two devices may be coupled directly, or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context dictates otherwise. Also, as used in the description herein, the meaning of “in” includes “in” and “on” unless the context dictates otherwise.

The phrases “in an embodiment,” “according to one embodiment,” and the like generally mean the particular feature, structure, or characteristic following the phrase is included in at least one embodiment of the present disclosure and may be included in more than one embodiment of the present disclosure. Importantly, such phrases do not necessarily refer to the same embodiment.

Exemplary embodiments will now be described more fully hereinafter with reference to the accompanying drawings, in which exemplary embodiments are shown. This disclosure may, however, be embodied in many different forms and should not be construed as limited to the embodiments set forth herein. These embodiments are provided so that this disclosure will be thorough and complete and will fully convey the scope of the disclosure to those of ordinary skill in the art. Moreover, all statements herein reciting embodiments of the disclosure, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating systems and methods embodying this disclosure. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this disclosure. Those of ordinary skill in the art further understand that the exemplary hardware, software, processes, methods, and/or operating systems described herein are for illustrative purposes and thus, are not intended to be limited to any particular named.

A system and method for automated audio furnishing amidst reading of a digital media is disclosed. The system provides an immersive reading experience to users (also referred to as readers) through AI-aided ambient audio (also termed as music) generation based on the user's reading speed. The generated ambient music generated advances along the varying progression of themes and moods in reading content facilitating the user with an immersive and multi-sensorial experience. In order to generate the music, the system scans the reading content of the digital media to pick out a general genre and vibe of the digital media. Upon picking out the general genre and vibe of the digital media, the system starts looking into various sections of the digital media to pick out their context. The system utilizes such general genres and corresponding contexts to generate music for each section using Artificial Intelligence (AI). Additionally, the system also determines a paragraph-to-paragraph transition and flow of the theme in the digital media. Further, when the reader is reading the digital media, the system tracks the user's eye movement and/or the head movement to determine the focus of the reader with respect to the displayed digital media. Accordingly, the system keeps track of the portion of the digital media that the reader is reading at a particular point of time as well as the reading speed to render the generated music accordingly while smoothly transitioning the generated music with the flow of the theme of the digital media to provide ambient and intune experience to the reader.

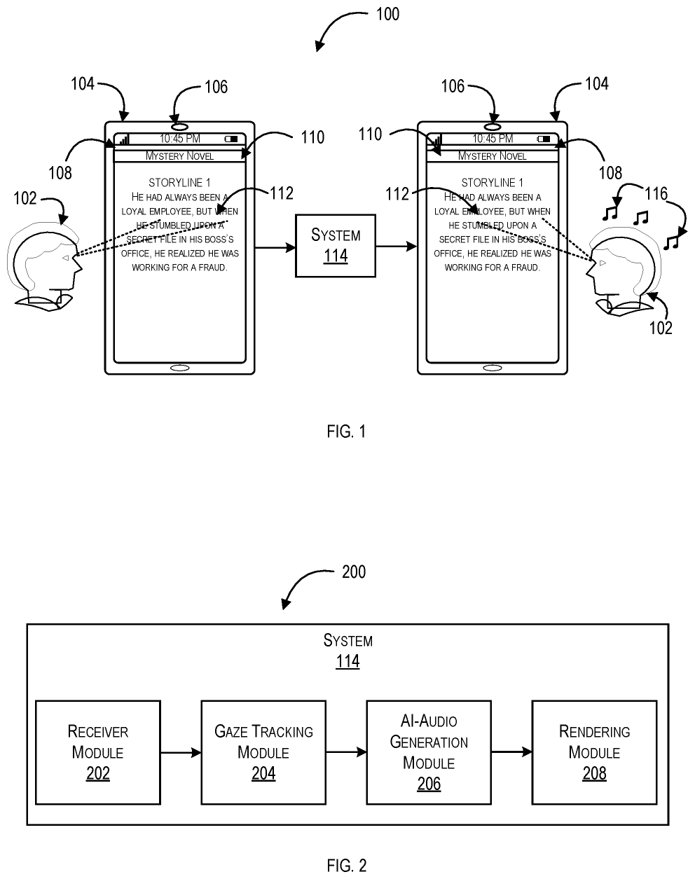

FIG. 1 illustrates a block diagram of an environment 100 of a system 114 for automated audio furnishing amidst reading of a digital media 110, in accordance with various embodiments of the present disclosure. In an embodiment, the environment 100 may include an electronic device 104 which, for the purpose of the present disclosure, corresponds to a digital display device having a camera. For example, the electronic device 104 may, without any limitation, include a mobile phone, a Personal Digital Assistant (PDA), a tablet, a desktop, a laptop, a television, and a smartboard The system 114 may, without departing from the scope of the disclosure, either be implemented on the electronic device 104 or be communicatively coupled to the electronic device 104. Further, the electronic device 104 may essentially include a camera 106 to monitor facial expressions (such as eye movement and head movement) of a user 102 and a user interface 108 to display the digital media 110 (e.g., a document like a book or an article, a website like a blog, an image like an image of notes, and a video like a slideshow of images) that has a readable content. Further, the system 114 may analyze the digital media 110 thoroughly to identify the genre of the digital media 110. Some non-limiting examples of the genres may be horror, thriller, comedy, romantic, or the like. Also, the system 114 may deeply analyze each section of the digital media 110 to identify the context of various sections. The context of various sections is similar to genres but is specific to the associated section and not the overall digital media 110, unlike the genre. In operation, the system 114 may receive the monitored facial expressions in real-time to identify the user focus area on the screen of the electronic device 104 to identify the portion of the digital media 110 that the user is reading in real time. Further, the system 114 may identify one or more keywords 112 associated with the context of the identified portion to generate and render a corresponding audio 116. Similarly, when the user 102 reads further, the system 114 identifies the corresponding keywords 112 with the new focus area to generate and render the corresponding audio 116 for associated keywords. Accordingly, the system 114 continuously renders audios 116 corresponding to the section of the digital media 110 being read to provide an immersive experience to the user 102.

FIG. 2 illustrates a block diagram 200 of the system 114 for automated audio furnishing amidst reading of the digital media 110, in accordance with various embodiments of the present disclosure. The system 100 may include a receiver module 202, a gaze tracking module 204, an Artificial Intelligence (AI)-audio generation module 206, and a rendering module 208. The receiver module 202, the gaze tracking module 204, the AI-audio generation module 206, and the rendering module 208 may be communicatively coupled to a memory and a processor of the system 114.

The processor may be configured to control the operations of the receiver module 202, the gaze tracking module 204, the AI-audio generation module 206, and the rendering module 208. In an embodiment of the present disclosure, the processor and the memory may form a part of a chipset installed in the system 114. In another embodiment of the present disclosure, the memory may be implemented as a static memory or a dynamic memory. In an example, the memory may be internal to the system 114, such as an onside-based storage. In another example, the memory may be external to the system 114, such as cloud-based storage. Further, the processor may be implemented as one or more microprocessors, microcomputers, digital signal processors, central processing units, state machines, logic circuitries, and/or any devices that manipulate signals based on operational instructions.

In an embodiment, the receiver module 202 may receive data associated with the digital media 110 that is displayed on an electronic device 104, display settings of the electronic device 104, and facial movement data of a user 102 reading the digital media 110 on the electronic device 104 in real-time. The data associated with the digital media 110 may, without any limitation, include title (such as “The tale of two ghosts”), genre (such as “horror”), and content (i.e., the readable/written content) of the digital media 110. The display settings of the electronic device 104 may correspond to the parameters associated with the display of the digital media 110 on the screen of the electronic device 104 to determine position of each word on the screen. The display settings may, without any limitation, include the position of the digital media on a display of the electronic device, a zoom level associated with the displayed digital media, or a combination thereof. The facial movement data may correspond to the data associated with eye-movement and/or head-movement of the user 102 while reading the digital media 110 on the electronic device 104. The facial movement data may be indicative of co-ordinates of the eyes with respect to the center of the screen, and/or co-ordinates of the center of the face (such as the nose) with respect to the center of the screen. Further, the facial movement data may, without any limitation, include one or more image frames of the user while reading the digital media on the electronic device.

In an embodiment, the gaze tracking module 204 may determine a portion of the digital media 110 being read in real-time. Such portion of the digital media 110 that is being read may be determined based on the received data associated with the digital media, display settings, real-time facial movement, or a combination thereof. In order to determine the portion of the digital media 110 being read, the gaze tracking module 204 may extract one or more features, such as ocular co-ordinates and head co-ordinates of the user 102, from the received facial movement data to identify a user focus position on a display of the electronic device 104 by analyzing the one or more extracted features. For example, the gaze tracking module 204 may utilize the one or more features to determine the movement of the eye of the user with respect to the centre of the screen to identify the position of the screen that the user 102 is looking at a point of time. After identifying the position at which the user is looking at a point of time, the gaze tracking module 204 may identify the content of the digital media being displayed in proximity of the identified user focus position, by way of received content and display settings, to determine the portion of the digital media 110 being read at that point of time. In an additional embodiment, the gaze tracking module 204 may further track the identified user focus position for determining a user's reading speed. Such determining may be made by identifying the rate of movement of the one or more features to identify the movement of the eyes and/or the head of the user 102 which will be proportional to the reading speed. In another additional embodiment, the user's reading speed may also be pre-determined and pre-stored based on a sample reading material.

In an embodiment, the AI-audio generation module 206 may generate an audio based on the received data associated with the digital media, the determined portion of the digital media, or a combination thereof. In order to generate the audio, the AI audio generation module 206 may identify the genre of the digital media 110 based on the received data and determine the context of the portion of the digital media being read in real-time by employing a Recurrent Neural Network (RNN), or Generative Adversarial Networks (GAN), or Markov Models, or transformer models. Further, based on the received genre and the determined context of the portion being read, the AI audio generation module 206 may generate the audio for such portion. It may be noted that such audio may be generated continuously while the user 102 is reading the digital media 110 and keeps on transiting continuously based on the keywords in user focus. In an embodiment, the AI-audio generation module 206 may identify adjacent portions, such next sentence and/or previous sentence of the digital media 110 being read. Further, the AI-module generation module 206 may generate and store the audio for such adjacent portions to allow smooth transitioning of the change from the first audio to the second while reading.

In an embodiment, the rendering module 208 may render the generated audio to the user 102 in the real-time, such that the user 102 hears the generated audio while reading the determined portion of the digital media 110. The rendering module 208 may utilize the user reading speed, as identified by the gaze tracking module 204 to render the generated audio 116, such as if the user reading speed is slower than a pre-defined speed then the rendering module 208 may repeat the generated audio, or reduce the playing speed of the generated audio, and on the other hand when the user reading speed is more than the pre-defined speed then the rendering module 208 may skip the generated audio or increase the playing speed of the generated audio.

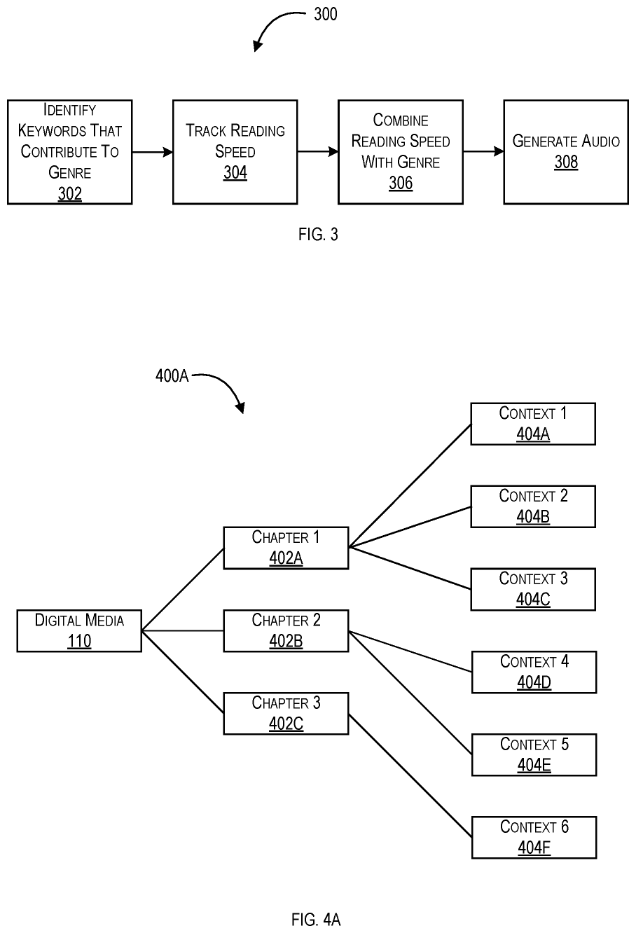

FIG. 3 illustrates an exemplary implementation 300 of the system 114 for automated audio furnishing amidst reading of the digital media 110, in accordance with various embodiments of the present disclosure. In an embodiment, the genre of the digital media 110 may not be received and a separate module may be utilized to identify keywords within the proximity of the identified user focus. Such identified keywords may contribute for the identification of the genre of the digital media 110, as shown by the block 302. Upon identifying the genre of the digital media 110, the system 114 may track the reading speed, as shown by the block 304, based on the mechanism as elaborated above. Further, the system 114 may then combine the reading speed with the identified genre, as shown by the block 306. Thereafter, the system 114 may generate an audio such that the generated audio 308 may be related to the genre and based on the user reading speed to eliminate the adjustment of the speed of playing the audio, or repetition, or skipping at the rendering module 208, as mentioned in previous paragraphs.

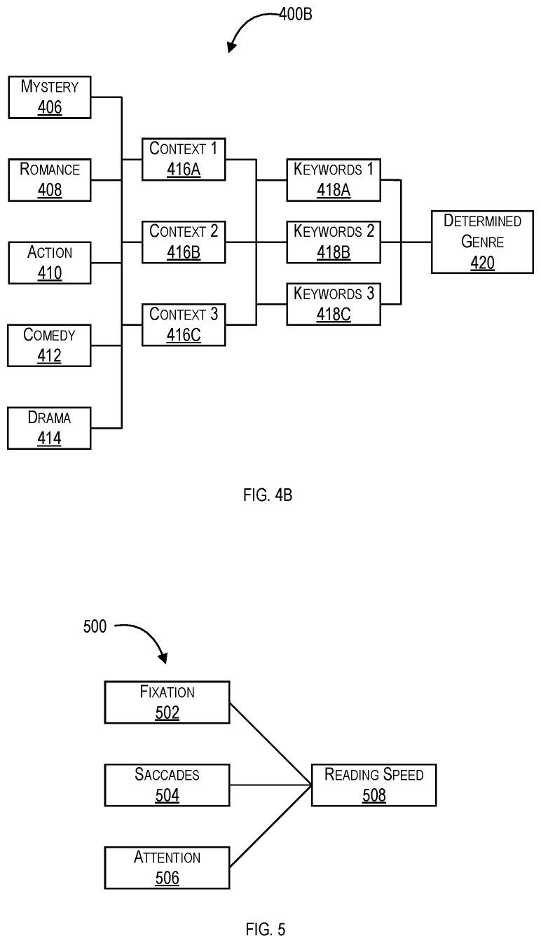

FIG. 4A illustrates a broad level block diagram 400A for determining various contexts of the digital media 110, in accordance with various embodiments of the present disclosure. FIG. 4B illustrates a narrow level block diagram 400B for determining context of a chapter of the digital media 110, in accordance with various embodiments of the present disclosure. In an embodiment, as shown in FIG. 4A, the AI audio generation module 206 may utilize the RNN model such as Hierarchical Attention Networks (HAN) to determine the context of each section of the digital media 110. Such HAN captures the context and relationships between words in a sentence and the relationships between sentences in a document and so are used to find the genre of the digital media 110. The HAN may consist of two levels of attention mechanisms i.e., word-level attention and sentence-level attention. The word-level attention is applied to the individual words in a sentence or a paragraph to identify which words are more important for classification. The sentence-level attention is applied to the entire sequence (i.e., sequence of sentences or paragraphs) to identify which sequences are more important for classification. The HAN model computes a weighted sum of the sentence representations, where the weights are determined by the sentence-level attention scores. These attention scores are also learned during training and are based on the relevance of each sequence to the classification task. In an embodiment, the dataset for training may be a collection of classic books that are in the public domain and available for free like the Gutenberg dataset having 60,000 books in various languages including English, French, German, Italian, and Portuguese. In an embodiment, the dataset for testing may include annotations for various attributes of the text, including genre, for individual sentences in a collection of novels, such as the BookNLP dataset.

In order to determine the context of each section, the AI audio generation module 206 may utilize such trained HAN model for splitting the digital media 110 into various chapters 402A. 402B, 402C (together called 402) and extracting the individual sentences along with their corresponding annotation for context from the BookNLP dataset. Further, the AI audio generation module 206 may concatenate the sentence embeddings into a single document embedding. Further, the HAN model may be utilized to predict the contexts for each chapter based on the concatenated document embeddings. For example, context 1 404A, context 2 404B, and context 3 404C for chapter 1 402A; context 4 404D and context 5 404E for chapter 2 402B; and context 6 404F for chapter 3 402C.

Further, as shown in FIG. 4B, for determining the context for each chapter, the HAN model may utilize one or more genres such as mystery 406, romance 408, action 410, comedy 412, and drama 414 for determining one or more specific contexts 416A, 416B, and 416C. The HAN model may determine a keyword 418A, 418B, and 418C associated with each specific context to determine the genre 420 of the chapter, for example, the mystery genre.

FIG. 5 illustrates a block diagram 500 for digital media progress tracking of the user 102 by the gaze tracking module 204, in accordance with various embodiments of the present disclosure. In an embodiment, the gaze tracking module 204 may utilize one or more models such as the Long Short-Term Memory (LSTM) neural network and Tobil Pro X2-30 trained and tested with datasets such as ZuCo Corpus dataset containing eye-tracking recordings of participants reading sentences with varying syntactic complexity. In order to determine the user focus and user reading speed, the gaze tracking module 204 may train the LSTM neural networks with the ZuCo corpus dataset which contains eye-tracking data and corresponding text passages from a variety of sources, such that the LSTM learns to predict reading speed in real-time based on eye-tracking data. Further, the Tobil Pro X2-30 model may be used to capture eye-tracking data (such as fixation 502, saccades 504, and attention 506) in real-time that can then be used as input to the LSTM neural networks for predicting reading speed 508.

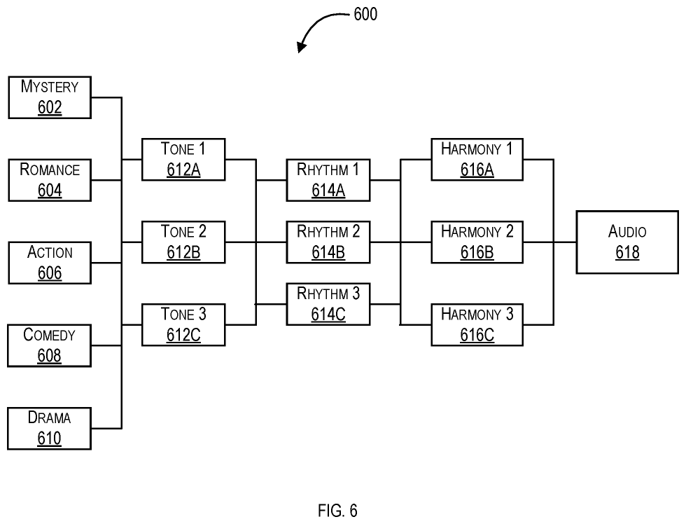

FIG. 6 illustrates a block diagram 600 for audio generation by the AI-audio generation module 206, in accordance with various embodiments of the present disclosure. In an embodiment, the AI-audio generation module 206 may utilize the GAN model that can generate new music by learning the patterns and structures of a given dataset. The generator model of the GAN model can be trained to generate new music by taking random input noise and transforming it into new music that is similar to the training data. Further, such a GAN model may be trained using training data having audio files or MIDI files that represent different musical genres and the testing data may be the direct genre to which it generates music. In an embodiment, the AI-audio generation module 206 may utilize such GAN model to identify music of one or more genres, such as mystery 602, romance 604, action 606, comedy 608, and drama 610, for the concerned context. Further, the AI-audio generation module 206 may generate one or more tones 612A, 612B, and 612C based on the identified one or more genres. Upon generating one or more tones, the AI-audio generation module 206 may generate a rhythm for each tone, for example, rhythm 1 614A for tone 1 612A, rhythm 2 614B for tone 2 612B, and rhythm 3 614C for tone 3 612C. Further, the AI-audio generation module 206 may generate a harmony for each rhythm i.e., harmony 1 616A, harmony 2 616B, and harmony 3 616C. Thereafter, the AI-audio generation module 206 may combine the generated harmonics to generate an audio 618, for identified genre such as the mystery genre.

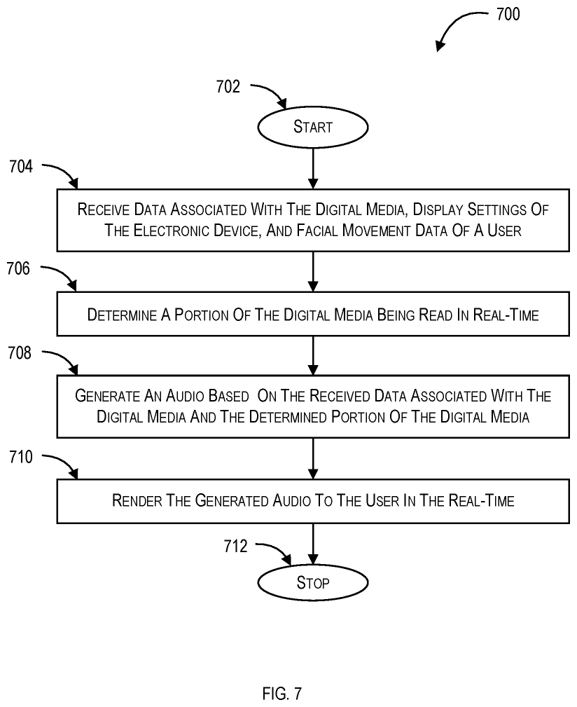

FIG. 7 illustrates a flowchart 700 of a method for automated audio furnishing amidst reading of a digital media, in accordance with an embodiment of the present disclosure. The method starts at step 702.

At first, at step 704, data associated with the digital media that is displayed on an electronic device, display settings of the electronic device, and facial movement data of a user reading the digital media on the electronic device in real-time may be received. The digital media corresponds to a media having textual content and includes, without any limitation, a document, a website, an image, and/or video. Further, the data associated with the digital media includes, without any limitation, the title, genre, and/or content of the digital media. Furthermore, the display settings may include, without any limitation, the position of the digital media on a display of the electronic device and/or a zoom level associated with the displayed digital media. Additionally, the facial movement data corresponds to data associated with eye-movement and/or head-movement of the user while reading the digital media on the electronic device. The facial movement data may include, without any limitation, one or more image frames, captured via a camera associated with the electronic device, of the user while reading the digital media on the electronic device. It may be understood that the electronic device for the purpose of the invention, may correspond to a digital display device having the camera and includes, without any limitation, a mobile phone, a Personal Digital Assistant (PDA), a tablet, a desktop, a laptop, a television, and/or a smartboard.

Further, at step 706, a portion of the digital media being read in real-time may be determined based on the received data associated with the digital media, display settings, real-time facial movement, or a combination thereof. In order to identify the portion of the digital media being read, the method may include the steps of extracting one or more features from the received facial movement data. The one or more features include, without any limitation, ocular co-ordinates and head co-ordinates of the user. The method may also include the steps of identifying a user focus position on a display of the electronic device by analyzing the one or more extracted features and identifying the content of the digital media being displayed in proximity of the identified user focus position to determine the portion of the digital media being read. Additionally, the method may also include the steps of determining a user's reading speed by tracking the identified user focus position.

Further, at step 708, an audio may be generated based on one of the received data associated with the digital media and/or the determined portion of the digital media. In order to generate the audio, the method may include the steps of identifying the genre of the digital media based on the received data, determining the context of the portion of the digital media being read in real-time by employing a Recurrent Neural Network (RNN) and generating the audio based on the identified genre of the digital media and/or the determined context of the portion being read by employing a Machine Learning (ML) model.

After that, at step 710, the generated audio may be rendered to the user in the real-time, such that the user hears the generated audio while reading the determined portion of the digital media. The rendering of the generated audio may be based on the user's reading speed. In some embodiments, the method may include the steps of identifying adjacent portions to the portion of the digital media being read and generating one or more audios based on the adjacent portions to facilitate the rendering module for smooth transitioning from one audio to another while rendering to the user. The method ends at step 712.

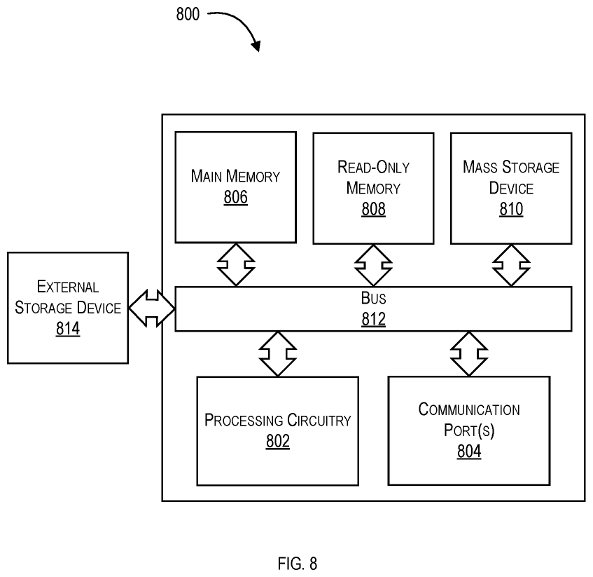

FIG. 8 illustrates an exemplary computer system in which or with which embodiments of the present disclosure may be utilized. As shown in FIG. 8, a computer system 800 includes an external storage device 814, a bus 812, a main memory 806, a read-only memory 808, a mass storage device 810, a communication port 804, and a processor 802.

Those skilled in the art will appreciate that computer system 800 may include more than one processor 802 and communication ports 804. Examples of processor 802 include, but are not limited to, an Intel® Itanium® or Itanium 2 processor(s), or AMD® Opteron® or Athlon MP® processor(s), Motorola® lines of processors, FortiSOC™ system on chip processors or other future processors. Processor 802 may include various modules associated with embodiments of the present disclosure.

Communication port 804 can be any of an RS-232 port for use with a modem-based dialup connection, a 10/100 Ethernet port, a Gigabit or 10 Gigabit port using copper or fiber, a serial port, a parallel port, or other existing or future ports. Communication port 804 may be chosen depending on a network, such as a Local Area Network (LAN), Wide Area Network (WAN), or any network to which the computer system 800 connects.

Memory 806 can be Random Access Memory (RAM), or any other dynamic storage device commonly known in the art. Read-Only Memory 808 can be any static storage device(s) e.g., but not limited to, a Programmable Read-Only Memory (PROM) chips for storing static information e.g., start-up or BIOS instructions for processor 802.

Mass storage 810 may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), e.g. those available from Seagate (e.g., the Seagate Barracuda 7200 family) or Hitachi (e.g., the Hitachi Deskstar 7K1000), one or more optical discs, Redundant Array of Independent Disks (RAID) storage, e.g. an array of disks (e.g., SATA arrays), available from various vendors including Dot Hill Systems Corp., LaCie, Nexsan Technologies, Inc. and Enhance Technology, Inc.

Bus 812 communicatively couples processor(s) 802 with the other memory, storage, and communication blocks. Bus 812 can be, e.g., a Peripheral Component Interconnect (PCI)/PCI Extended (PCI-X) bus, Small Computer System Interface (SCSI), USB, or the like, for connecting expansion cards, drives, and other subsystems as well as other buses, such a front side bus (FSB), which connects processor 802 to a software system.

Optionally, operator and administrative interfaces, e.g., a display, keyboard, and a cursor control device, may also be coupled to bus 812 to support direct operator interaction with the computer system. Other operator and administrative interfaces can be provided through network connections connected through communication port 804. An external storage device 814 can be any kind of external hard-drives, floppy drives, IOMEGA® Zip Drives, Compact Disc-Read-Only Memory (CD-ROM), Compact Disc-Re-Writable (CD-RW), Digital Video Disk-Read Only Memory (DVD-ROM). The components described above are meant only to exemplify various possibilities. In no way should the aforementioned exemplary computer system limit the scope of the present disclosure.

The disclosed system and method (together termed as disclosed mechanism) for automated audio furnishing amidst the reading of the digital media. The disclosed mechanism enhances the reader's reading experience by creating a multi-sensorial immersive reading experience. The disclosed mechanism generates music that matches the context of the reading material as read by the reader based on the reader's music preferences. The disclosed mechanism provides an immersive experience by combining the generated music with the reading speed of the reader to sync their real-time reading time. In order to do so, the disclosed mechanism tracks and records the user's reading speed and accommodates for changes in the speed with respect to attention span/situation/environment while creating a smooth transition with the music as and when the tone/mood of the reading material changes. Since the disclosed mechanism engages both auditory and visual learners, thereby promoting reading to a wider audience. Since the disclosed mechanism utilizes AI to generate music, the generation of music is at a faster pace with more personalization, thus curating more personal experiences for the readers.

While embodiments of the present disclosure have been illustrated and described, it will be clear that the disclosure is not limited to these embodiments only. Numerous modifications, changes, variations, substitutions, and equivalents will be apparent to those skilled in the art, without departing from the spirit and scope of the disclosure, as described in the claims.

Thus, it will be appreciated by those of ordinary skill in the art that the diagrams, schematics, illustrations, and the like represent conceptual views or processes illustrating systems and methods embodying this disclosure. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this disclosure. Those of ordinary skill in the art further understand that the exemplary hardware, software, processes, methods, and/or operating systems described herein are for illustrative purposes and, thus, are not intended to be limited to any particular named.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of this document terms “coupled to” and “coupled with” are also used euphemistically to mean “communicatively coupled with” over a network, where two or more devices can exchange data with each other over the network, possibly via one or more intermediary device.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refer to at least one of something selected from the group consisting of A, B, C . . . and N, the text should be interpreted as requiring only one element from the group, not A plus N, or B plus N, etc.

While the foregoing describes various embodiments of the disclosure, other and further embodiments of the disclosure may be devised without departing from the basic scope thereof. The scope of the disclosure is determined by the claims that follow. The disclosure is not limited to the described embodiments, versions, or examples, which are included to enable a person having ordinary skill in the art to make and use the disclosure when combined with information and knowledge available to the person having ordinary skill in the art.

What is claimed:

1. A system for automated audio furnishing amidst reading of a digital media, the system comprising:
a receiver module to receive data associated with the digital media that is displayed on an electronic device, display settings of the electronic device, and facial movement data of a user reading the digital media on the electronic device in real-time;
a gaze tracking module to determine a portion of the digital media being read in real-time based at least on: the received data associated with the digital media, display settings, and real-time facial movement;
an Artificial Intelligence (AI) audio generation module to generate an audio based at least on one of: the received data associated with the digital media and the determined portion of the digital media; and
a rendering module to render the generated audio to the user in the real-time, such that the user hears the generated audio while reading the determined portion of the digital media.

2. The system of claim 1, wherein the digital media corresponds to a media having textual content and includes at least one of: a document, a website, an image, and a video.

3. The system of claim 1, wherein the data associated with the digital media includes at least one of: title, genre, and content of the digital media.

4. The system of claim 1, wherein the electronic device corresponds to a digital display device having a camera and includes at least one of: a mobile phone, a Personal Digital Assistant (PDA), a tablet, a desktop, a laptop, a television, and a smartboard.

5. The system of claim 1, wherein the display settings include at least one of: position of the digital media on a display of the electronic device and a zoom level associated with the displayed digital media.

6. The system of claim 1, wherein the facial movement data corresponds to data associated with eye-movement and head-movement of the user while reading the digital media on the electronic device.

7. The system of claim 1, wherein the facial movement data includes one or more image frames of the user while reading the digital media on the electronic device and may be captured via a camera associated with the electronic device.

8. The system of claim 1, wherein the gaze tracking module is configured to:
extract one or more features from the received facial movement data, wherein the one or more features include at least one of: ocular co-ordinates and head co-ordinates of the user;
identify a user focus position on a display of the electronic device by analyzing the one or more extracted features; and
identify content of the digital media being displayed in proximity of the identified user focus position to determine the portion of the digital media being read.

9. The system of claim 8, wherein the gaze tracking module is further configured to determine a user's reading speed by tracking the identified user focus position.

10. The system of claim 9, wherein the rendering module renders the generated audio based on the user reading speed.

11. The system of claim 1, wherein the AI audio generation module is configured to:
identify genre of the digital media based on the received data;
determine context of the portion of the digital media being read in real-time by employing a Recurrent Neural Network (RNN); and
generate the audio based at least on one of: the identified genre of the digital media and the determined context of the portion being read by employing a Machine Learning (ML) model.

12. The system of claim 11, wherein the AI audio generation module is further configured to:
identify adjacent portions to the portion of the digital media being read; and
generate one or more audios based on the adjacent portions to facilitate the rendering module for smooth transitioning from one audio to another while rendering to the user.

13. A method for automated audio furnishing amidst reading of a digital media, the method comprising:
receiving data associated with the digital media that is displayed on an electronic device, display settings of the electronic device, and facial movement data of a user reading the digital media on the electronic device in real-time;
determining a portion of the digital media being read in real-time based at least on: the received data associated with the digital media, display settings, and real-time facial movement;
generating an audio based at least on one of: the received data associated with the digital media and the determined portion of the digital media; and
rendering the generated audio to the user in the real-time, such that the user hears the generated audio while reading the determined portion of the digital media.

14. The method of claim 13,
wherein the digital media corresponds to a media having textual content and includes at least one of: a document, a website, an image, and a video,
wherein the data associated with the digital media includes at least one of: title, genre, and content of the digital media,
wherein the electronic device corresponds to a digital display device having a camera and includes at least one of: a mobile phone, a Personal Digital Assistant (PDA), a tablet, a desktop, a laptop, a television, and a smartboard, and
wherein the display settings include at least one of: position of the digital media on a display of the electronic device and a zoom level associated with the displayed digital media.

15. The method of claim 13,
wherein the facial movement data corresponds to data associated with eye-movement and head-movement of the user while reading the digital media on the electronic device, and
wherein the facial movement data includes one or more image frames of the user while reading the digital media on the electronic device and may be captured via a camera associated with the electronic device.

16. The method of claim 13, further comprises:
extracting one or more features from the received facial movement data, wherein the one or more features include at least one of: ocular co-ordinates and head co-ordinates of the user;
identifying a user focus position on a display of the electronic device by analyzing the one or more extracted features; and
identifying content of the digital media being displayed in proximity of the identified user focus position to determine the portion of the digital media being read.

17. The method of claim 16, further comprises determining a user's reading speed by tracking the identified user focus position.

18. The method of claim 17, further comprises rendering the generated audio based on the user reading speed.

19. The method of claim 13, further comprises:
identifying genre of the digital media based on the received data;
determining context of the portion of the digital media being read in real-time by employing a Recurrent Neural Network (RNN); and
generating the audio based at least on one of: the identified genre of the digital media and the determined context of the portion being read by employing a Machine Learning (ML) model.

20. The method of claim 19, further comprises:
identifying adjacent portions to the portion of the digital media being read; and
generating one or more audios based on the adjacent portions to facilitate the rendering module for smooth transitioning from one audio to another while rendering to the user.
